(19) United States
(12) Patent Application Publication
(10) Pub. No.: US 2025/0078545 A1
(43) Pub. Date: Mar. 6, 2025

(54) CELL IMAGE ANALYSIS APPARATUS AND CELL IMAGE ANALYSIS METHOD

(71) Applicants: CANON KABUSHIKI KAISHA, Tokyo (JP); CANON MEDICAL SYSTEMS CORPORATION, Tochigi (JP)

(72) Inventors: YUKITERU MASUDA, Kanagawa (JP); YOJI YAMAMOTO, Tokyo (JP); SHUHEI TOBA, Kanagawa (JP)

(21) Appl. No.: 18/813,652

(22) Filed: Aug. 23, 2024

(30) Foreign Application Priority Data
Aug. 30, 2023 (JP) 2023-139638

(51) Int. Cl. G06V 20/69; G06V 10/62

(52) U.S. Cl. CPC G06V 20/698; G06V 10/62; G06V 20/695

(57) ABSTRACT

Provided is a cell image analysis apparatus including: an image acquisition unit configured to acquire time-series images, which include the same cell colony; a region extraction unit configured to extract a region of the same cell colony included in each of the time-series images; a feature value extraction unit configured to extract an image feature value from the region; a feature value estimation unit configured to estimate, through use of the image feature value, the image feature value regarding the same cell colony assumed to be obtained at a given time point at which none of the time-series images is acquired; and an evaluation unit configured to evaluate, through use of the image feature value, at least any one selected from the group consisting of the same cell colony and a condition for the cell culture.

### BACKGROUND OF THE INVENTION

### Field of the Invention

The disclosure of the present application relates to a cell image analysis apparatus, a cell image analysis method, and a non-transitory storage medium having stored thereon a program for causing a computer to execute the cell image analysis method according to the disclosure of the present application.

### Description of the Related Art

In recent years, in the field of cell culture, attention has been given to a cell image analysis technology for picking up an image of a cell to be cultured and analyzing the image, thereby being able to perform a non-invasive full inspection, in-process monitoring of a cell culture state, and the like. As a specific method for cell image analysis, there has been proposed a method in which image feature values including a size, a shape, and a texture of a colony are extracted from a picked-up image of a cell colony to perform evaluation regarding culture of the cell colony from those image feature values.

The image feature value is a value that changes not only with a feature to be evaluated for a cell colony but also simply with growth of the cell colony. Thus, in order to appropriately perform evaluation based on each image feature value, the image feature value is preferred to be used for the evaluation in consideration of a change in the image feature value involved in the growth of the cell colony.

In Japanese Patent Application Laid-Open No. 2015-061516, there is disclosed a technology for extracting a feature value, such as an area, relating to a degree of maturity of a cell from a picked-up image of the cell to evaluate a differentiation state of the cell in combination with other image feature values.

Degrees of maturity of colonies generated during cell culture may differ from each other even in the same culture vessel. Thus, in the method as disclosed in Japanese Patent Application Laid-Open No. 2015-061516, there has been a problem in that, at a time of comparing feature values between different colonies to evaluate the colonies, the degrees of maturity of colonies derived from colony areas or the like cannot be set to the same degree for the comparison.

As another example, a method of acquiring time-series images at high frequency to select and compare images of different colonies that are as close to each other as possible in the degree of maturity is conceivable. However, in order to increase the frequency of acquiring time-series images, it is required to increase a data acquisition rate thereof, and in order to increase the data acquisition rate, it is required to reduce an image pickup area or lower a resolution. As a result, there has been a problem in that the number of colonies to be evaluated becomes insufficient or the quality of images for use in analysis becomes insufficient.

### SUMMARY OF THE INVENTION

The present invention has been made in view of the above-described problems. That is, the present invention has an object to provide a cell image analysis technology capable of evaluating a cell image with high accuracy under the same criterion regarding an image feature value that changes in a process of cell culture.

According to one aspect of the present invention, there is provided a cell image analysis apparatus including: an image acquisition unit configured to acquire time-series images, which were acquired at two or more time points different from each other on a time series during cell culture, and which include the same cell colony; a region extraction unit configured to extract a region of the same cell colony included in each of the time-series images; a feature value extraction unit configured to extract an image feature value from the region extracted by the region extraction unit; a feature value estimation unit configured to estimate, through use of the image feature value extracted by the feature value extraction unit, the image feature value regarding the same cell colony assumed to be obtained at a given time point at which none of the time-series images is acquired; and an evaluation unit configured to evaluate, through use of the image feature value obtained through the estimation by the feature value estimation unit, at least any one selected from the group consisting of the same cell colony and a condition for the cell culture.

Further, according to another aspect of the present invention, there is provided a cell image analysis apparatus including: an image acquisition unit configured to acquire time-series images, which were acquired at two or more time points different from each other on a time series during cell culture, and which include the same cell colony; a region extraction unit configured to extract a region of the same cell colony included in each of the time-series images; a feature value extraction unit configured to extract, from the region extracted by the region extraction unit, a first image feature value corresponding to a feature that changes in accordance with a culture time period of the cell culture and a second image feature value corresponding to a feature to be used for evaluation; a feature value estimation unit configured to estimate the second image feature value corresponding to a given value regarding the first image feature value; and an evaluation unit configured to evaluate, through use of the second image feature value estimated by the feature value estimation unit, at least any one selected from the group consisting of the same cell colony and a condition for the cell culture.

Further, according to still another aspect of the present invention, there is provided a cell image analysis method including: an image acquisition step of acquiring time-series images, which were acquired at two or more time points different from each other on a time series during cell culture, and which include the same cell colony; a region extraction step of extracting a region of the same cell colony included in each of the time-series images; a feature value extraction step of extracting an image feature value from the region of the same cell colony in a plurality of images included in the time-series images; a feature value estimation step of estimating, through use of the image feature value extracted in the feature value extraction step, the image feature value regarding the same cell colony assumed to be obtained at a given time point at which none of the time-series images is acquired; and an evaluation step of evaluating, through use of the image feature value obtained through the estimation in the feature value estimation step, one of the same cell colony or a condition for the cell culture.

Further, according to yet another aspect of the present invention, there is provided a cell image analysis method including: an image acquisition step of acquiring time-series images, which were acquired at two or more time points different from each other on a time series during cell culture, and which include the same cell colony; a region extraction step of extracting a region of the same cell colony included in each of the time-series images; a feature value extraction step of extracting, from the region extracted in the region extraction step, a first image feature value corresponding to a feature that changes in accordance with a culture time period of the cell culture and a second image feature value corresponding to a feature to be used for evaluation; a feature value estimation step of estimating the second image feature value corresponding to a given value regarding the first image feature value; and an evaluation step of evaluating, through use of the second image feature value obtained through the estimation in the feature value estimation step, at least any one selected from the group consisting of the same cell colony and a condition for the cell culture.

Further features of the present invention will become apparent from the following description of exemplary embodiments with reference to the attached drawings.

### BRIEF DESCRIPTION OF THE DRAWINGS

FIG. 1 is a diagram for illustrating a configuration example of a cell image analysis apparatus according to a first embodiment.

FIG. 2 is a block diagram for illustrating a hardware configuration of the cell image analysis apparatus according to the first embodiment.

FIG. 3 is a flow chart for illustrating an outline of a cell image analysis method according to the first embodiment.

FIG. 4 is explanatory tables for showing an example of specific processing in a case of performing estimation through interpolation processing in the cell image analysis method according to the first embodiment.

FIG. 5 is explanatory tables for showing an example of specific processing in a case of performing estimation through extrapolation processing in the cell image analysis method according to the first embodiment.

FIG. 6 is a diagram for illustrating a configuration example of a cell image analysis apparatus according to an example of a second embodiment.

FIG. 7 is a flow chart for illustrating an outline of a cell image analysis method according to the example of the second embodiment.

FIG. 8 is explanatory tables for showing an example of specific processing in a case of performing estimation through the interpolation processing in the cell image analysis method according to the example of the second embodiment.

FIG. 9 is a diagram for illustrating a configuration example of a cell image analysis apparatus according to a modification example of the second embodiment.

FIG. 10 is a flow chart for illustrating an outline of a cell image analysis method according to the modification example of the second embodiment.

FIG. 11A and FIG. 11B are graphs for showing examples of results of evaluating culture states of colonies of iPS cell lines.

### DESCRIPTION OF THE EMBODIMENTS

Now, embodiments of the present invention are described in detail with reference to the accompanying drawings. The embodiments exemplified below do not limit the invention defined in claims, and not all of combinations of features described in the embodiments are essentially required for solving means of the present invention.

### First Embodiment

A cell image analysis apparatus according to the present embodiment is an apparatus that extracts an image feature value from picked-up time-series images of a cell colony and uses the obtained image feature value to estimate the image feature value regarding the same cell colony assumed to be obtained at a given time point at which no time-series image is acquired. The cell colony is hereinafter sometimes referred to simply as “colony.”

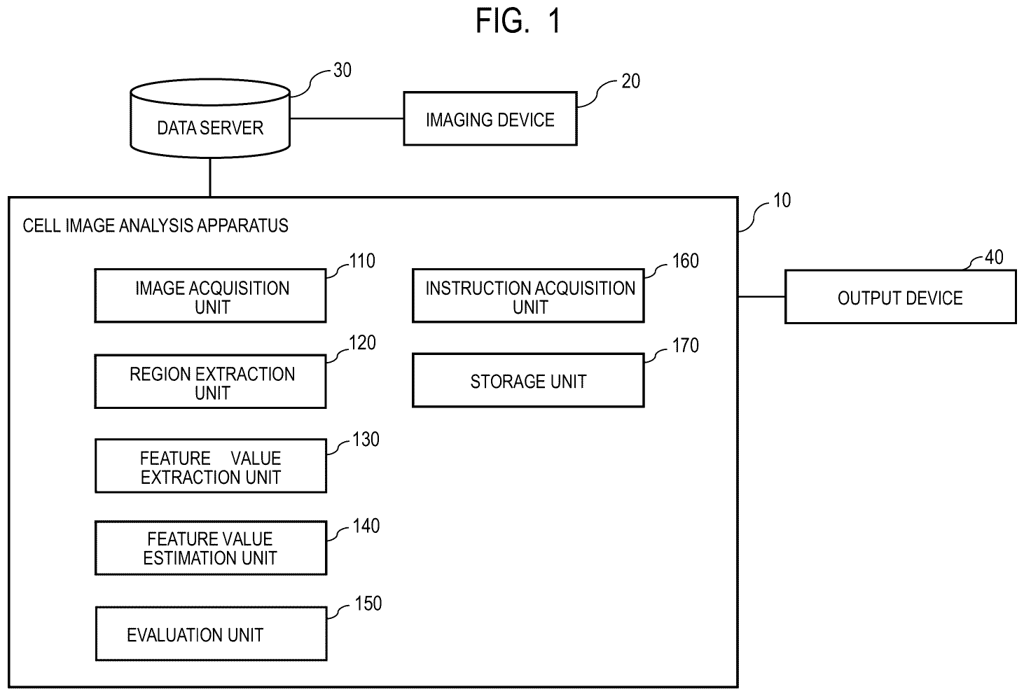

FIG. 1 is an illustration of a configuration example of an apparatus for carrying out a cell image analysis method according to the present embodiment.

As illustrated in FIG. 1, a cell image analysis apparatus 10 according to the present embodiment includes an image acquisition unit 110, a region extraction unit 120, a feature value extraction unit 130, a feature value estimation unit 140, an evaluation unit 150, an instruction acquisition unit 160, and a storage unit 170. In addition, the cell image analysis apparatus 10 is externally connected to a data server 30 and an output device 40. An imaging device 20 is, for example, a phase contrast microscope having an image pickup function and an incubation function for cells, and has a function of generating time-series images of a cell colony by performing image pickup, for example, every 24 hours during culture of the cells. The output device 40 is a device that outputs information from the cell image analysis apparatus 10 to the outside, and is typically a user interface for presenting information to a user. Examples of the output device 40 include a display and a speaker.

The data server 30 holds time-series images regarding cell colonies picked up by the imaging device 20. The data server 30 is, for example, a recording medium, such as a hard disk drive (HDD) or a solid-state drive (SSD), connected to the imaging device 20 and the cell image analysis apparatus 10 through networks. The data server 30 has a function of storing each of cell colony images picked up by the imaging device 20. A configuration of the cell image analysis apparatus 10 according to the present embodiment is not limited to the above-described configuration, and the cell image analysis apparatus 10 may include therein, for example, a part or all of the imaging device 20, the data server 30, and the output device 40.

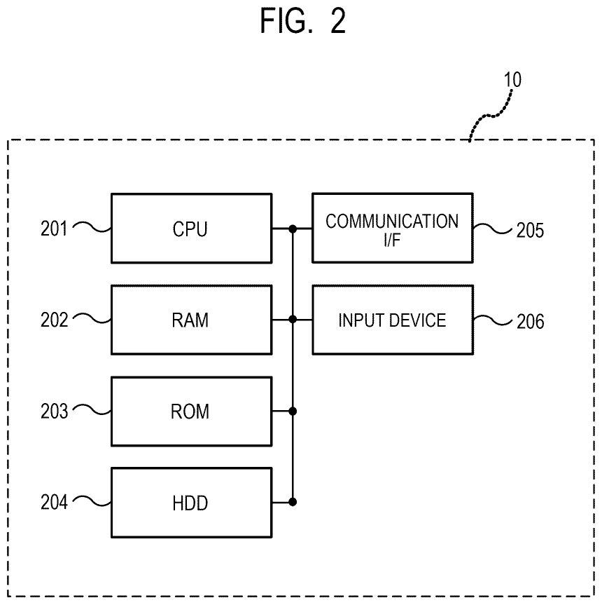

FIG. 2 is a block diagram for illustrating a hardware configuration of the cell image analysis apparatus 10 according to the present embodiment. The cell image analysis apparatus 10 includes a central processing unit (CPU) 201, a random-access memory (RAM) 202, a read-only memory (ROM) 203, a hard disk drive (HDD) 204, a communication interface (I/F) 205, and an input device 206. These units are connected to each other via a bus or the like.

The CPU 201 is a processor that reads programs stored in the ROM 203 and the HDD 204 into the RAM 202 and executes the programs, and performs calculation processing, control of each unit of the cell image analysis apparatus 10, and the like. The processing performed by the CPU 201 may include extraction of a region of a cell colony, estimation of an image feature value, and evaluation of the cell colony or a culture condition.

The RAM 202 is a volatile storage medium and functions as a work memory when the CPU 201 executes a program. The ROM 203 is a non-volatile storage medium, and stores firmware and the like necessary for the operation of the cell image analysis apparatus 10. The HDD 204 is a nonvolatile storage medium, and stores a program used for processing such as the extraction of the region of a cell colony and the estimation of the image feature value in the present embodiment, image data, and the like.

The communication I/F 205 is a communication device based on a standard such as Wi-Fi (trademark), Ethernet (trademark), or Bluetooth (trademark). The communication I/F 205 is used for communication with, for example, the imaging device 20, other computer, or the like.

The input device 206 is a device for inputting information to the cell image analysis apparatus 10, and is typically a user interface for a user to operate the cell image analysis apparatus 10. Examples of the input device 206 include a keyboard, buttons, a mouse, and a touch panel.

Note that the configuration of the cell image analysis apparatus 10 described above is merely an example, and can be changed as appropriate. Examples of processors that can be mounted on the cell image analysis apparatus 10 include a Graphics Processing Unit (GPU), an Application Specific Integrated Circuit (ASIC), and a Field Programmable Gate Array (FPGA) in addition to the CPU 201. A plurality of processors may be provided, or a plurality of processors may perform processing in a distributed manner. The function of storing information such as image data in the HDD 204 may be provided not in the cell image analysis apparatus 10 but in the data server 30. The HDD 204 may be a storage medium such as an optical disk, a magneto-optical disk, or a solid-state drive (SSD).

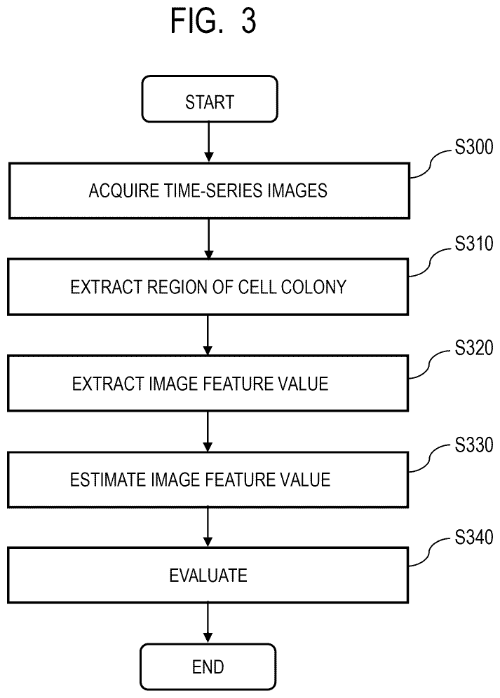

An example of the cell image analysis method using the cell image analysis apparatus 10 according to the present embodiment is described below with reference to FIG. 3, which is a flow chart for illustrating an outline of the cell image analysis method.

First, in Step S300, which is an image acquisition step, the image acquisition unit 110 receives a request for processing from the user, and acquires time-series images of a cell colony stored in the data server 30 and picked up by the imaging device 20. The “time-series images of a cell colony” as used herein refer to images, which were acquired at two or more time points different from each other on a time series during cell culture, and which include the same cell colony. Examples of the time-series images of a cell colony include time-series images picked up at predetermined intervals by whole-well imaging for picking up an image of a whole well from seeding of cells until subculture thereof. The image acquisition unit 110 is connected to the data server 30 through a network or the like, and can acquire a plurality of time-series images of a cell colony that are stored in the data server 30.

When the image acquisition unit 110 acquires each of the time-series images, the image acquisition unit 110 simultaneously acquires a time stamp associated with each image.

The cell image analysis apparatus 10 includes the instruction acquisition unit 160 capable of receiving instruction information input from the user, and the image acquisition unit 110 may acquire the time-series images from the data server 30 based on the instruction information acquired by the instruction acquisition unit 160.

The time-series images of a cell colony may be stored in advance in the storage unit 170 included in the cell image analysis apparatus 10, and the image acquisition unit 110 may acquire the time-series images of a cell colony stored in advance from the storage unit 170.

Subsequently, in Step S310, which is a region extraction step, the region extraction unit 120 extracts, over respective image frames, a region of the same cell colony included in each of the time-series images of the cell colony acquired in Step S300 by the image acquisition unit 110. After that, identification of the same colony over respective image frames is performed for each extracted colony region by tracking processing or the like. In this case, the colony to be subjected to extraction of a region is not limited to one type of colony, and a region can be extracted from a plurality of types of colonies as the requirement arises. Specifically, the colony to be subjected to the extraction may be selected based on the instruction information input by the user and acquired by the instruction acquisition unit 160, or, for example, processing for automatically extracting all colonies included in a well may be performed. In another case, processing for automatically extracting only colonies that satisfy a predetermined condition, instead of all colonies included in a well, may be performed. At this time, each colony is extracted by, for example, being given a colony ID so that the same cell colony over the respective image frames can be distinguished from different cell colonies.

The “same cell colony over the respective image frames” as used herein refers to a colony formed by seeding a cell for culture followed by dividing and growing of the same cell in a process of culture. That is, for example, in a case in which five cells are seeded at a time of the seeding and each of the cells forms a cell colony through the cell division, it is assumed that five independent cell colonies have been formed, and the colonies are distinguished from one another as mutually different cell colonies over the respective image frames.

As a specific example, processing for the extraction of a region can be achieved by region division processing or the like for each image frame included in the time-series images of the cell colony. In the region division processing, the fact that pixel values of the cell colony to be extracted and pixel values of a background have different tendencies is utilized to form regions in each of which respective pixels are integrated with pixels adjacent thereto having similar pixel values, to thereby perform processing for division into a colony region and a background region.

Further, specific examples of the tracking processing include subjecting each colony region in the respective image frames included in cell colony time-series images to determination as to whether or not a colony of interest is the same as a colony in the previous frame based on an overlap amount with each colony region in the previous frame. Calculation of the overlap amount in a case in which an area of a cell colony region included in a current image frame is set to S(A1) and an area of a cell colony region included in the previous image frame is set to S(A2) is described. The overlap amount between cell colonies in this case is calculated by the following expression.

$$Overlap = \frac{S ( A 1 ⋂ A 2 )}{min ( S ( A 1 ) , S ( A 2 ) )}$$

The colony regions between which an overlap region calculated by the above-described expression is the largest are determined to be regions of the same colony. The above-described method for determination of the same colony is merely an example, and the determination of the same colony may be performed by another approach, for example, a method of obtaining an optical flow such as a Lucas-Kanade method.

Region information on each colony region extracted in each image frame may be held in the storage unit 170, for example, in a form of having a subject colony region cropped from each cell colony time-series image acquired by the image acquisition unit 110, for example. The storage unit 170 may also hold, as the region information, an image mask representing a contour shape of the subject colony region.

Subsequently, in Step S320, which is a feature value extraction step, the feature value extraction unit 130 extracts the image feature value from the region of the cell colony extracted by the region extraction unit 120. The “image feature value” as used herein refers to a numerical value obtained by converting information regarding each feature obtained from an image of a cell colony. The number of types of feature values extracted by the feature value extraction unit 130 is not limited to one, and two or more types of image feature values corresponding to two or more types of features may be extracted. The image feature value extracted by the feature value extraction unit 130 may be an image feature value corresponding to a morphological feature such as an area, a length, a peripheral length, or a circularity of a subject colony, or a texture feature of the subject colony may be extracted as the image feature value.

Examples of the texture feature include an average value, a variance, a contrast, a skewness, a kurtosis, an energy, and an entropy of pixels derived from a gray-level co-occurrence matrix and a pixel histogram of the subject colony. A power spectrum obtained by performing a discrete Fourier transform on a subject colony image may also be extracted as the image feature value. The above-described image feature values are merely examples, and the image feature value to be extracted is not limited thereto. A new image feature value may also be obtained by combining those image feature values through principal component analysis or the like.

The feature value extraction unit 130 extracts the image feature value for each region of the cell colony extracted from each image frame by the region extraction unit 120. At this time, the feature value extraction unit 130 may extract the image feature value from an image that uses a mask to show only the colony region from which the image feature value is to be extracted. Further, the image feature value may be extracted by combining an original image acquired by the image acquisition unit 110 and information regarding the region of the cell colony extracted by the region extraction unit 120. In the extraction of the image feature value performed by the feature value extraction unit 130, an appropriate extraction method can be selected depending on a type of the image feature value to be extracted.

Subsequently, in Step S330, which is a feature value estimation step, the feature value estimation unit 140 uses the image feature value extracted by the feature value extraction unit 130 to estimate the image feature value regarding the cell colony assumed to be obtained at a given time point at which no time-series image is acquired. The image feature value (image feature value extracted by the feature value extraction unit 130) to be used for the estimation by the feature value estimation unit 140 is the image feature value extracted for the same cell colony as the cell colony for which the image feature value is to be estimated.

In Step S330, the above-described given time point at which no time-series image relating to the estimation performed by the feature value estimation unit 140 is acquired may be a time point determined in advance. Further, the instruction information acquired by the instruction acquisition unit 160 may include information specifying the given time point at which no time-series image is acquired, and the feature value estimation unit 140 may estimate the image feature value regarding the above-described same cell colony assumed to be obtained at the time point specified by the above-described instruction information. At this time, the instruction information acquired by the instruction acquisition unit 160 may be held in the storage unit 170, or may be input from the user through any input interface.

When the above-described given time point at which no time-series image is acquired falls within a range of a time period including time points at which the time-series images were acquired on the time series during the cell culture, the feature value estimation unit 140 performs the estimation through interpolation processing.

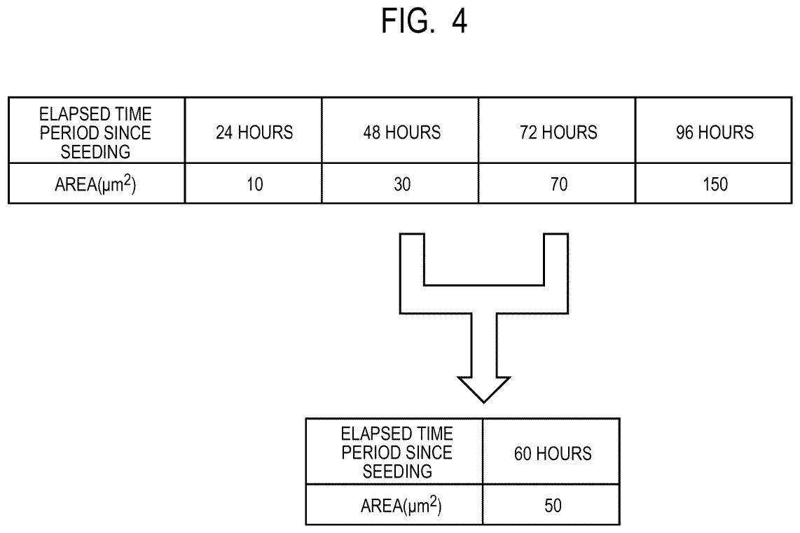

An example of specific processing in a case of performing the estimation through the interpolation processing by the feature value estimation unit 140 is described with reference to FIG. 4. FIG. 4 shows an example of a case in which the image feature value extracted in Step S320 by the feature value extraction unit 130 and estimated in Step S330 by the feature value estimation unit 140 has area values of the same cell colony. In the example shown in FIG. 4, the area values of the same cell colony which serve as the image feature value are extracted from the time-series images acquired every 24 hours after the seeding of the cells. More specifically, the area values of the same cell colony which serve as the image feature value are extracted based on the time-series images formed of four image frames picked up 24 hours, 48 hours, 72 hours, and 96 hours after the seeding. In the example shown in FIG. 4, an area of the cell colony assumed to be obtained at a time point 60 hours after the seeding, which is specified as the above-described given time point at which no time-series image is acquired, is estimated. The example shown in FIG. 4 is merely an example for description, and the image feature value to be estimated is not limited to the area value of the cell colony, and may be another morphological feature value, a texture feature value, or a combination of a plurality of such feature values.

In the estimation processing, the feature value estimation unit 140 selects a plurality of values to be used for the estimation from the image feature value extracted by the feature value extraction unit 130. The values selected at this time are preferred to be values of the image feature value included in the time-series images acquired at two or more consecutive time points including the time points immediately before and after the above-described given time point at which no time-series image is acquired. Specifically, in the example shown in FIG. 4, an image feature value assumed to be obtained at the time point 60 hours after the seeding is estimated, and hence it is preferred to use values of the image feature value extracted from the image frames acquired at two or more consecutive time points which include the image frames acquired 48 hours after the seeding and 72 hours after the seeding.

In this case, processing for performing the estimation through use of the values of the image feature value extracted from two image frames acquired 48 hours and 72 hours after the seeding is described.

In the example shown in FIG. 4, the area value of the cell colony extracted from the image frame acquired 48 hours after the seeding is 30 μm², and the area value of the cell colony extracted from the image frame acquired 72 hours after the seeding is 70 μm². In this case, in the example shown in FIG. 4, the feature value estimation unit 140 assumes that the area value of the cell colony and a culture time period have a linear relationship from the time point 48 hours after the seeding to the time point 72 hours after the seeding, and estimates that an area value of the cell colony assumed to be obtained 60 hours after the seeding is 50 μm².

An example of assuming that the area value of the cell colony and the culture time period have a linear relationship when the feature value estimation unit 140 performs the estimation has been described above, but it is not limited to the above-described example how the image feature value is assumed to have changed in accordance with the culture time period at a time of the estimation. An assumption regarding a mode of change of the image feature value in accordance with the culture time period can be changed as appropriate in accordance with a feature corresponding to the image feature value to be estimated and a specific value of the image feature value to be used for the estimation. For example, when it is already known or expectable that the image feature value to be estimated conforms to a specific function with respect to the culture time period, the specific function can be used for the estimation. As another example, when the values of the image feature value extracted from the image frames acquired at three or more consecutive time points are to be used for the estimation, a polynomial approximation may be performed on a relationship between elapsed time periods since the seeding and the image feature value, and a thus obtained polynomial may be used for the estimation. Specifically, in the example shown in FIG. 4, it is also possible to perform spline interpolation through use of, for example, the area values respectively acquired 24 hours, 48 hours, 72 hours, and 96 hours after the seeding and estimate the area value assumed to be obtained 60 hours after the seeding. In the spline interpolation, compared to linear interpolation, respective data points are connected by a smooth curve with a curvature changing continuously, and hence a smoother interpolation result can be obtained. In addition, the interpolation can be performed by expressing a relationship between image pickup times and the area values in a polynomial manner by Lagrangian interpolation or the like.

In the above-described example, the example in which the values of the image feature value extracted from the image frames acquired at the two time points immediately before and after the above-described given time point at which no time-series image is acquired are used for the estimation has been described, but a combination of the image frames to be used for the estimation is not limited thereto. For example, the feature value estimation unit 140 may use, for the estimation, all the values of the image feature value extracted from all the image frames included in the time-series images.

In the above-described example shown in FIG. 4, a method in which a value of an image feature value assumed to be obtained at a timing included in a range of a series of times at which time-series images were picked up is estimated by performing interpolation processing through use of values of the image feature value extracted from image frames immediately before and after the timing has been described. However, the timing at which the image feature value is to be estimated in the present invention is not limited to a timing within the range of the series of times at which time-series images were picked up, and an image feature value assumed to be obtained at a timing included outside the range of the series of times at which time-series images were picked up may be estimated. That is, when the above-described given time point at which no time-series image is acquired falls out of the range of the time period including the time points at which the time-series images were acquired on the time series during the cell culture, the feature value estimation unit 140 performs the estimation through extrapolation processing.

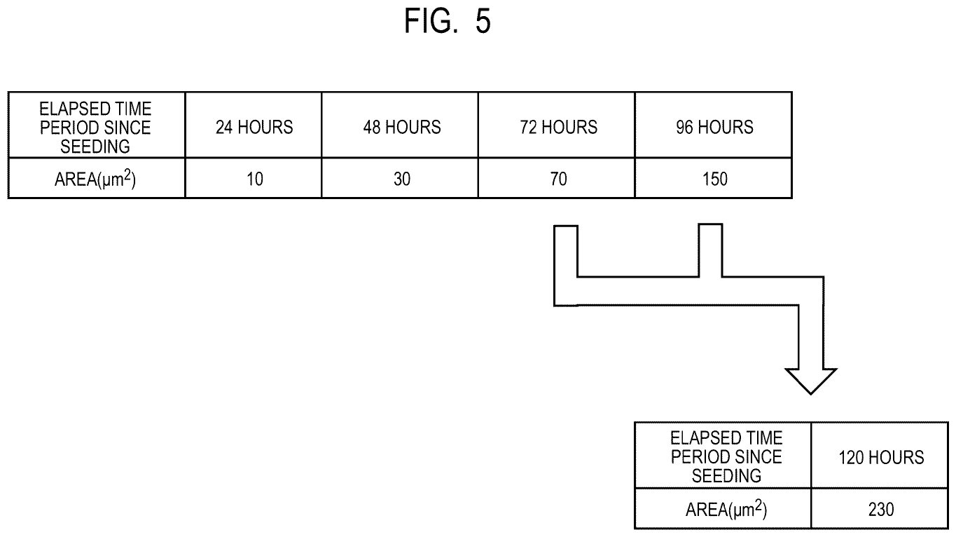

An example of specific processing in a case of performing the estimation through the extrapolation processing by the feature value estimation unit 140 is described with reference to FIG. 5. In the example shown in FIG. 5, processing in the case in which the image feature value extracted in Step S320 by the feature value extraction unit 130 and estimated in Step S330 by the feature value estimation unit 140 has area values of the same cell colony in the same manner as in the above-described example shown in FIG. 4 is described. In the example shown in FIG. 5, in the same manner as in the above-described example shown in FIG. 4, the area values of the same cell colony which serve as the image feature value are extracted based on the time-series images formed of four image frames picked up 24 hours, 48 hours, 72 hours, and 96 hours after the seeding. In the example shown in FIG. 5, an area of the cell colony assumed to be obtained at a time point 120 hours after the seeding, which is specified as the above-described given time point at which no time-series image is acquired, is estimated.

In the estimation processing, the feature value estimation unit 140 selects a plurality of values to be used for the estimation from the image feature value extracted by the feature value extraction unit 130. The values selected at this time are preferred to be values of the image feature value included in the time-series images acquired at two or more consecutive time points that are closest to the above-described given time point at which no time-series image is acquired. Specifically, in the example shown in FIG. 5, it is preferred to use values of the image feature value extracted from the image frames acquired at two or more consecutive time points which include the image frames acquired 72 hours after the seeding and 96 hours after the seeding.

In this case, processing for estimating, by extrapolation, a colony area assumed to be obtained 120 hours after the seeding through use of the values of the image feature value extracted from two image frames acquired 72 hours and 96 hours after the seeding is described.

In the example shown in FIG. 5, the area value of the cell colony extracted from the image frame acquired 72 hours after the seeding is 70 μm², and the area value of the cell colony extracted from the image frame acquired 96 hours after the seeding is 150 μm². In this case, in the example shown in FIG. 5, the feature value estimation unit 140 assumes that the area value of the cell colony and a culture time period have a linear relationship from the time point 72 hours after the seeding to the time point 120 hours after the seeding, and estimates that an area value of the cell colony assumed to be obtained 120 hours after the seeding is 230 μm².

When the feature value estimation unit 140 performs the estimation by the extrapolation, it is not limited to the above-described example how the image feature value is assumed to have changed in accordance with the culture time period at the time of the estimation, in the same manner as in the above-described example case of performing the estimation by interpolation shown in FIG. 4. That is, the assumption regarding the mode of change of the image feature value in accordance with the culture time period can be changed as appropriate in accordance with a feature corresponding to the image feature value to be estimated and a specific value of the image feature value to be used for the estimation.

In a case of performing the estimation by the extrapolation as well as in the case of performing the estimation by the interpolation, a combination of the image frames to be used for the estimation is not limited thereto, and, for example, all the image frames included in the time-series images may be used.

In the example shown in FIG. 5, a case of performing the estimation by the extrapolation on the assumption that the culture time period and the image feature value have a linear relationship has been described. However, in the case of performing the estimation by the extrapolation as well as in the case of performing the estimation by the interpolation, a relationship other than the linear relationship can also be used as the relationship between the image feature value and the culture time period. It is also possible to perform the spline interpolation through use of, for example, the area values respectively acquired 24 hours, 48 hours, 72 hours, and 96 hours after the seeding and use a thus obtained spline to estimate the area value assumed to be obtained 120 hours after the seeding. In addition, the extrapolation processing can also be performed through use of a polynomial that expresses the relationship between the image pickup times and the area values by the Lagrangian interpolation or the like.

In the case in which the feature value estimation unit 140 performs the estimation by the extrapolation, when the above-described given time point at which no time-series image is acquired is spaced far apart from the range of the time period including the time points at which the time-series images were acquired, the estimation in an appropriate manner may be difficult in some cases. Accordingly, the feature value estimation unit 140 may have a function of generating a result indicating that the estimation is impossible when the above-described given time point at which no time-series image is acquired is spaced far apart by a predetermined time period or more from the range of the time period including the time points at which the time-series images were acquired. In this case, it can be set as appropriate in accordance with a specific situation how far the above-described given time point at which no time-series image is acquired is to be spaced, in order to generate the result indicating that the estimation is impossible, apart from the range of the time period including the time points at which the time-series images were acquired.

When the feature value estimation unit 140 performs the estimation by the extrapolation, it is possible to estimate the area value of the colony assumed to be obtained at an image pickup timing that is outside the range of the time period including the time points at which the time-series images were acquired. Thus, for example, an area value of the colony assumed to be obtained in a future can be predicted at an early stage of the culture, or it can be examined to what extent a colony the culture of which has failed at some midpoint due to an external factor is assumed to have originally grown.

When the feature value extraction unit 130 extracts two or more types of image feature values, the feature value estimation unit 140 can also estimate the two or more types of image feature values.

Subsequently, in Step S340, which is an evaluation step, the evaluation unit 150 uses the image feature value obtained through the estimation by the feature value estimation unit 140 to carry out evaluation on at least any one selected from the group consisting of a cell colony and a condition for cell culture. The evaluation unit 150 can perform, based on an evaluation criterion, the evaluation on the image feature value to be subjected to the evaluation, and may determine, for example, whether or not the image feature value regarding the cell colony estimated by the feature value estimation unit 140 exceeds a predetermined reference value included in the evaluation criterion. Examples of details of the evaluation include determination of whether a colony is currently differentiated or non-differentiated and evaluation of a colony property such as a differentiation ability or a growth rate of a subject colony.

An example of a case in which the evaluation unit 150 analyzes a growth rate of a colony based on the area value estimated by the feature value estimation unit 140 is described below. In the example described below, the evaluation unit 150 uses a criterion that “when the area value assumed to be obtained 40 hours after a start of growth of a seeded colony falls below 60 μm², the colony is determined to be a growth-deficient colony.” The image feature value to be used for evaluation in Step S340 is not limited to the area value, and may be another morphological feature value, a texture feature value, or a combination of a plurality of such feature values.

In general, a cell does not always start to grow immediately after the seeding, and a timing of starting to grow differs for each single cell that is an origin of each colony. Thus, as in the examples described above with reference to FIG. 4 and FIG. 5, in a case of an image pickup setting in which images are picked up discontinuously, for example, every 24 hours, a time-series image that is picked up at a timing at which 40 hours have just elapsed since the start of growth of the colony is not always acquired.

In view of this, for example, the user inputs, through any input interface, instruction information specifying that the image feature value assumed to be obtained 40 hours after the start of growth of the seeded colony is to be estimated by the feature value estimation unit 140. The cell image analysis apparatus 10 acquires the instruction information by the instruction acquisition unit 160, and the feature value estimation unit 140 estimates the area of the cell colony based on the instruction information. Assuming that the subject colony starts to grow 20 hours after the seeding, for example, in the example shown in FIG. 4, the time point 40 hours after the start of growth of the seeded colony corresponds to the time point 60 hours after the seeding. Thus, the feature value estimation unit 140 estimates the area of the cell colony assumed to be obtained 60 hours after the seeding, and the area value is estimated to be 50 μm². Then, the evaluation unit 150 performs the evaluation based on the criterion that “when the area value assumed to be obtained 40 hours after a start of growth of a seeded colony falls below 60 μm², the colony is determined to be a growth-deficient colony,” and thus the colony to be evaluated can be evaluated as a growth-deficient colony. In the above-described example, information that “the subject colony started to grow 20 hours after the seeding” may be included in the above-described instruction information, or the cell image analysis apparatus 10 may have a function of automatically performing prediction based on the image feature value extracted by the feature value extraction unit 130.

An example of performing the evaluation through use of one type of estimated image feature value has been described above, but the feature value estimation unit 140 can also estimate two or more types of image feature values, and the evaluation can be performed through use of the thus estimated two or more types of image feature values.

The evaluation unit 150 may evaluate a degree of correlation between the image feature value obtained through the estimation by the feature value estimation unit 140 and at least any one selected from the group consisting of a predetermined feature of a cell colony and a condition for cell culture. Examples of the predetermined feature of the cell colony include a type of a cell line, production or non-production of a specific substance, and presence or absence of canceration. Meanwhile, the examples of the condition for the cell culture include: presence or absence or a concentration of a specific culture medium component; a pH; a temperature; a humidity; presence or absence or a concentration of a specific atmospheric composition component such as carbon dioxide gas; and illuminance.

When the evaluation unit 150 evaluates the above-described degree of correlation, two or more cell culture processes different from each other in, for example, the predetermined feature of the cell colony or the condition for the cell culture with which the degree of correlation is to be evaluated are performed. Then, time-series images are picked up in each cell culture process, and the cell image analysis apparatus 10 according to the present embodiment is used to carry out the cell image analysis method according to the present embodiment.

A case in which the image feature value to be used when the evaluation unit 150 evaluates the degree of correlation is the area of the cell colony and the condition for the cell culture to be used for the evaluation is the pH is further described as a specific example.

First, a certain cell line “a” is subjected to a cell culture process A performed at a pH of 5.0 and a cell culture process B performed at a pH of 7.0, and time-series images are picked up by the imaging device 20 during each culture process. Subsequently, the image analysis described above is carried out on the time-series images picked up in the respective cell culture processes. At this time, the feature value estimation unit 140 is assumed to estimate the area of the cell colony assumed to be obtained 40 hours after the start of growth of the seeded colony.

Then, the evaluation unit 150 compares an area A of the cell colony estimated in the cell culture process A and an area B of the cell colony estimated in the cell culture process B to each other, and can evaluate that the correlation between the area of the cell colony and the pH becomes larger as a difference between the area A and the area B becomes larger. In this case, an average value or the like of areas estimated from a plurality of mutually different cell colonies is used as each of the area A and the area B, to thereby be able to evaluate the degree of correlation more accurately. With such evaluation, an influence of the pH during the culture on the growth rate of the cell line “a” can be evaluated based on an evaluation result obtained by the evaluation unit 150.

In the above-described example, the example in which the image feature value to be used when the evaluation unit 150 evaluates the degree of correlation is only one type, namely, the colony area has been described, but, for example, a value obtained by combining two or more types of image feature values through principal component analysis or the like may be used for evaluation.

The evaluation unit 150 can output a result of performing the evaluation to the output device 40 through a network or the like, and can present the evaluation result to the user.

### Second Embodiment

In the first embodiment, an aspect in which the feature value estimation unit 140 estimates a value of an image feature value through use of values of the image feature value extracted from images picked up at mutually different times among the time-series images acquired by the image acquisition unit 110 has been described. However, in the method according to the first embodiment, for example, when it is desired to compare the values of the image feature value of different colonies with the same degree of growth of the colonies, optimum image pickup timings for the comparison are required to be designated for the respective colonies by the user, thereby leading to an increase in required labor.

In a method according to a second embodiment described below, for example, at a timing at which one type of image feature value reflecting the degree of growth of the colony, such as a colony area value, assumes a given value, comparison in another type of image feature value is performed. This enables easy comparison to be performed under a state in which the degrees of growth of the respective colonies are brought close to each other.

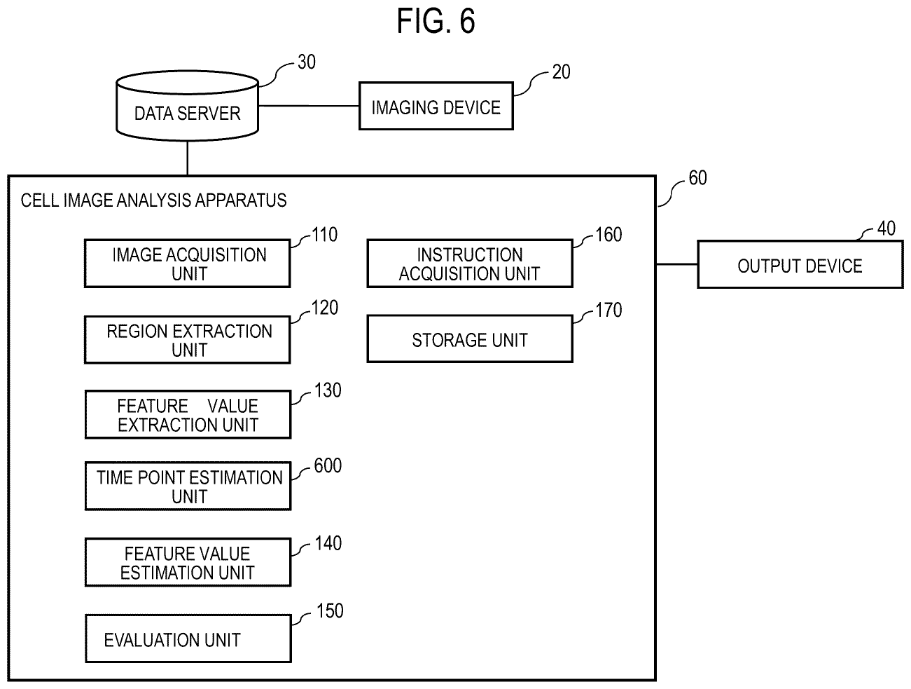

FIG. 6 is a diagram for illustrating a configuration example of an apparatus for carrying out a cell image analysis method according to an example of the second embodiment. A cell image analysis apparatus 60 according to the example of the present embodiment has the same configuration as that of the cell image analysis apparatus 10 according to the first embodiment, except that the cell image analysis apparatus 60 includes a time point estimation unit 600. A hardware configuration of the cell image analysis apparatus 60 can be set to be the same as that of the cell image analysis apparatus 10 according to the first embodiment.

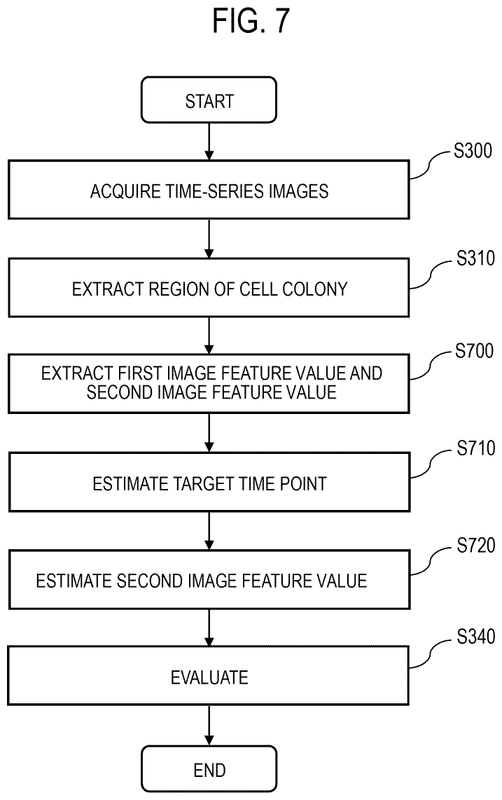

An example of the cell image analysis method according to the example of the present embodiment is described below with reference to FIG. 7, which is a flow chart for illustrating an outline of the cell image analysis method. In FIG. 7, each step of performing the same processing as that of the cell image analysis method according to the first embodiment is assigned the same step number as that of FIG. 3. The processing steps of Step S300, Step S310, and Step S340 are substantially the same between the cell image analysis method according to the example of the present embodiment and the cell image analysis method according to the first embodiment, and hence descriptions thereof are omitted.

In the example of the present embodiment, in Step S700, the feature value extraction unit 130 extracts a first image feature value and a second image feature value from the region of the cell colony extracted by the region extraction unit 120. In this case, the first image feature value is an image feature value corresponding to a feature that changes in accordance with the culture time period of the cell culture. Further, the second image feature value is an image feature value corresponding to a feature to be used for evaluation by the user based on a result obtained by the evaluation unit 150 in the subsequent processing.

As the first image feature value, it is preferred to use an image feature value relating to a size of the colony. Specifically, it is preferred that the first image feature value be at least any one selected from the group consisting of a colony area, a colony volume, a colony contour length, and an average cell area.

Each of the first image feature value and the second image feature value extracted by the feature value extraction unit 130 is not limited to one type, and the feature value extraction unit 130 may extract two or more types of image feature values as the first image feature values or the second image feature values.

Subsequently, in Step S710, which is a time point estimation step, the time point estimation unit 600 estimates a target time point that is a time point at which the first image feature value of the cell colony has a given value. Specifically, the time point estimation unit 600 estimates the above-described target time point from values of the first image feature value extracted by the feature value extraction unit 130 and the time stamps associated with the time-series images including the regions of the cell colony from which the respective values of the first image feature value were extracted. The time point estimation unit 600 is not always required to estimate a specific time point as the target time point, and may only estimate a relative positional relationship on the time series between the target time point and a time point at which each time-series image was acquired.

The above-described given value regarding the first image feature value may be a value determined in advance. Further, the instruction information acquired by the instruction acquisition unit 160 may include information specifying the above-described given value regarding the first image feature value, and the feature value estimation unit 140 may estimate the image feature value based on the above-described instruction information. At this time, the instruction information acquired by the instruction acquisition unit 160 may be held in the storage unit 170, or may be input from the user through any input interface.

Subsequently, in Step S720, which is a feature value estimation step, the feature value estimation unit 140 determines an image frame to be used for estimating the second image feature value from information regarding the target time point estimated in Step S710 by the time point estimation unit 600, and estimates the second image feature value.

When the above-described target time point falls within the range of the time period including the time points at which the time-series images were acquired on the time series during the cell culture, the feature value estimation unit 140 estimates, through the interpolation processing, the second image feature value corresponding to the above-described given value regarding the first image feature value. At this time, the feature value estimation unit 140 is preferred to perform the interpolation processing through use of the second image feature value included in the time-series images acquired at two or more consecutive time points including the time points immediately before and after the above-described target time point.

Further, when the above-described target time point falls out of the range of the time period including the time points at which the time-series images were acquired on the time series during the cell culture, the feature value estimation unit 140 estimates, through the extrapolation processing, the second image feature value corresponding to the above-described given value regarding the first image feature value. At this time, the feature value estimation unit 140 is preferred to perform the extrapolation processing through use of the second image feature value included in the time-series images acquired at two or more consecutive time points on the time series that are closest to the above-described target time point.

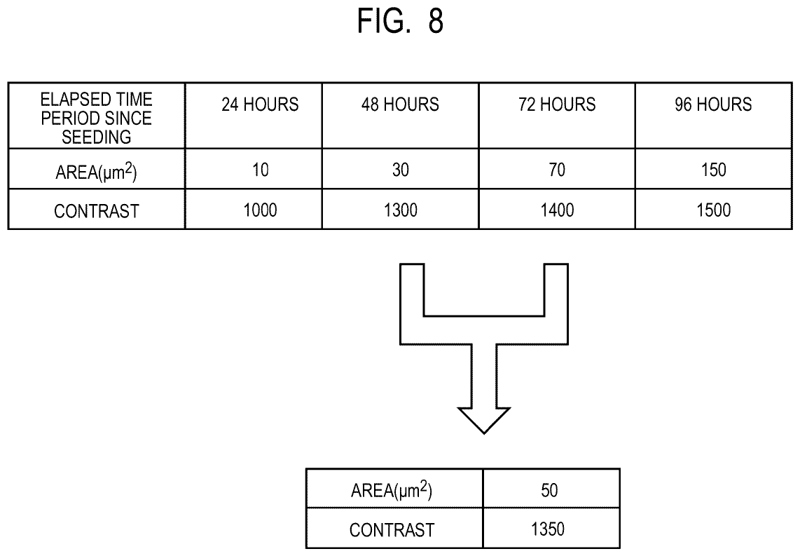

An example of specific processing in a case of performing the estimation through the interpolation processing by the feature value estimation unit 140 is described with reference to FIG. 8. FIG. 8 shows an example of a case in which the first image feature value extracted in Step S320 by the feature value extraction unit 130 is the area value of the cell colony and the second image feature value is a contrast value calculated from a histogram of an image texture. In the example shown in FIG. 8, the first image feature value and the second image feature value are extracted from the time-series images acquired every 24 hours after the seeding of the cells. More specifically, each image feature value is extracted based on the time-series images formed of the four image frames picked up 24 hours, 48 hours, 72 hours, and 96 hours after the seeding. In the example shown in FIG. 8, a contrast value assumed to be obtained when the above-described given value regarding the colony area serving as the first image feature value is 50 μm² is estimated. The first image feature value serving as a reference for the degree of growth is not limited to the area value, and may be another morphological feature value or a texture feature value. The second image feature value to be estimated is not limited to the contrast value, and may be another morphological feature value, a texture feature value, or a combination of a plurality of feature values.

At this time, the time point estimation unit 600 estimates, from the area value extracted by the feature value extraction unit 130 and the elapsed time periods since the seeding corresponding to the respective area values, that a time point at which the colony area is 50 μm² is between a time point at which the elapsed time period since the seeding is 48 hours and a time point at which the elapsed time period since the seeding is 72 hours. A method of the estimation performed by the time point estimation unit 600 is not particularly limited, and can be determined as appropriate in accordance with a feature corresponding to the image feature value to be estimated and a specific value of the image feature value to be used for the estimation.

The feature value estimation unit 140 selects a plurality of image frames required for the estimation of the second image feature value based on information on the target time point estimated by the time point estimation unit 600. The target time point estimated by the time point estimation unit 600 is between the time point at which the elapsed time period since the seeding is 48 hours and the time point at which the elapsed time period since the seeding is 72 hours, and hence the image frames picked up 48 hours and 72 hours after the seeding, which are time points before and after the above-described target time point, are used in this case.

The interpolation processing performed by the feature value estimation unit 140 in the example of the present embodiment is the same as the interpolation processing performed by the feature value estimation unit 140 in the first embodiment, and only the reference used thereby for the estimation differs therebetween. That is, in the estimation processing, in the first embodiment, the estimation is performed with reference to the information regarding the time points associated with the time-series images, while in the present embodiment, the estimation is performed with reference to the first image feature value.

In the above-described example, the first image feature value (area) obtained 48 hours after the seeding is 30 μm², and the second image feature value (contrast) obtained at this time is 1,300. Meanwhile, the first image feature value (area) obtained at 72 hours after the seeding is 70 μm², and the second image feature value (contrast) obtained at this time is 1,400. Thus, as shown in FIG. 8, assuming that the area of the cell colony and the contrast have a linear relationship between the time point 48 hours after the seeding and the time point 72 hours after the seeding, the contrast is estimated to be 1,350 when the above-described given value regarding the first image feature value is 50 μm². A combination of the image frames to be used for the estimation is not limited to the above-described example. For example, all the image frames included in a time-series images may be used.

The method of the estimation through the interpolation processing has been described above in detail, but the estimation through the extrapolation processing can be achieved in the same manner as that described in the first embodiment, except that only the reference used for the estimation differs.

The above description has been given by taking an example in which the cell image analysis apparatus 60 includes the time point estimation unit 600 that estimates the target time point, but the feature value estimation unit 140 may have the function of the time point estimation unit 600 described above.

### Modification Example of Second Embodiment

In the second embodiment, instead of utilizing the function of the time point estimation unit 600 described in the example described above, a regression model obtained from the first image feature value and the second image feature value extracted by the feature value extraction unit 130 may be utilized. At this time, the feature value estimation unit 140 can estimate the second image feature value corresponding to the given value regarding the first image feature value based on the regression model created by a regression model creation unit.

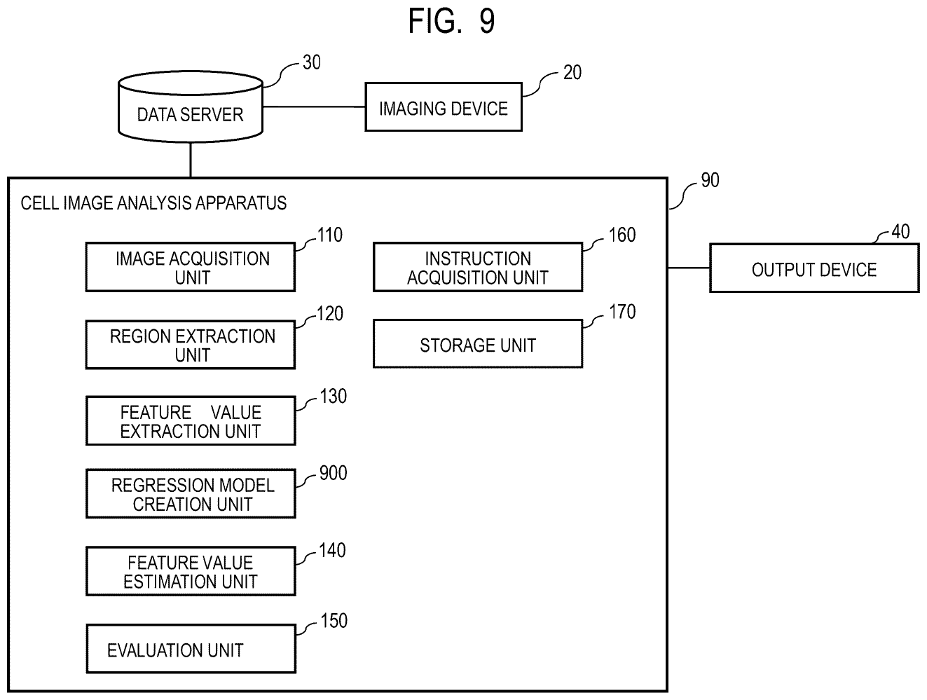

FIG. 9 is a diagram for illustrating a configuration example of an apparatus for carrying out a cell image analysis method according to a modification example of the second embodiment. A cell image analysis apparatus 90 according to this modification example has the same configuration as that of the cell image analysis apparatus 60, except that the cell image analysis apparatus 90 includes a regression model creation unit 900 instead of the time point estimation unit 600. A hardware configuration of the cell image analysis apparatus 90 can be set to be the same as that of the cell image analysis apparatus 10 according to the first embodiment.

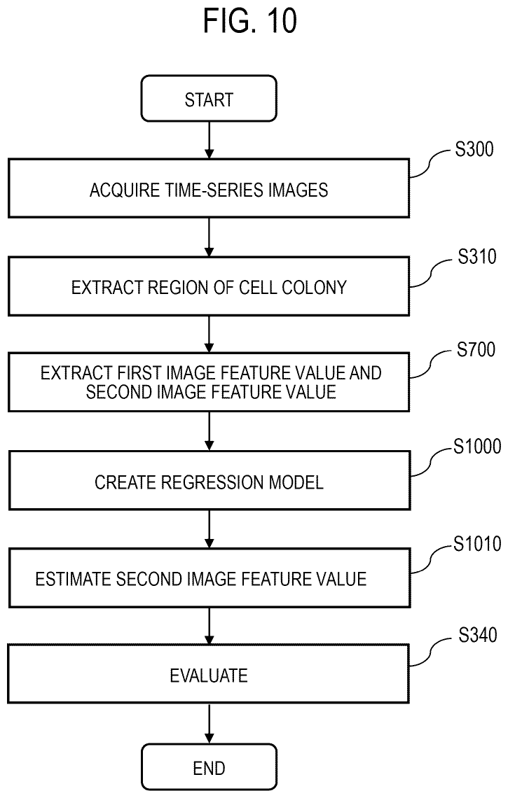

FIG. 10 is a flow chart for illustrating an outline of an example of the cell image analysis method according to this modification example. In FIG. 10, each step of performing the same processing as that of the cell image analysis method described with reference to FIG. 7 for the second embodiment is assigned the same step number as that of FIG. 7. The processing steps of Step S300, Step S310, Step S340, and Step S700 are substantially the same between the cell image analysis method according to this modification example and the cell image analysis method described with reference to FIG. 7 for the second embodiment, and hence descriptions thereof are omitted.

In this modification example, in Step S1000, which is a regression model creation step, the regression model creation unit 900 creates a regression model through use of the first image feature value and the second image feature value extracted by the feature value extraction unit 130. After that, in Step S1010, which is a feature value estimation step, the feature value estimation unit 140 uses the regression model created in Step S1000 to estimate the second feature value corresponding to the above-described given value regarding the first image feature value.

For example, in the case of the first image feature value (area) and the second image feature value (contrast) extracted by the feature value extraction unit 130 as shown in FIG. 8, the regression model creation unit 900 creates a regression model for a relationship between the area and the contrast. When a regression model represented as, for example, “(contrast)=181×Ln (area)+620” is created, the feature value estimation unit 140 can estimate that the contrast is 1,328 when the area is 50 μm² through use of the regression model. In this case, in order to create a regression model, the regression model creation unit 900 is not always required to use all values of the first image feature value and the second image feature value, and may perform processing such as removing values that appear to clearly contain significant errors.

The regression model creation unit 900 may have a function of evaluating validity or likelihood of the created regression model. In this case, the created regression model may be used for the estimation processing by the feature value estimation unit 140 only when the created regression model has accuracy equal to or more than a predetermined degree. Further, when any one or both of the first image feature value and the second image feature value have a plurality of types, the regression model creation unit 900 may create regression models for a plurality of combinations thereof. In addition, at this time, the validity of the created plurality of regression models may be evaluated, and only a regression model having accuracy equal to or more than the predetermined degree may be used for the estimation processing by the feature value estimation unit 140.

The above description has been given by taking an example in which the cell image analysis apparatus 90 further includes the regression model creation unit 900 that creates the regression model, but the feature value estimation unit 140 may have the function of the regression model creation unit 900 described above.

Any one of the embodiments described above is merely an example of implementation for carrying out the present invention, and the technical scope of the present invention is not to be construed in a limiting manner due to those embodiments. That is, the present invention can be carried out in various forms without departing from the technical idea of the invention or major features of the invention. For example, an embodiment in which a configuration of a part of any one of the embodiments is added to another embodiment or an embodiment in which a configuration of a part of any one of the embodiments is substituted with a configuration of a part of another embodiment is also to be understood as an embodiment to which the present invention is applicable.

The present invention may also be achieved by executing the following processing. Specifically, software (program) for achieving one or more of the functions of the above-described embodiments by causing a computer (or CPU, MPU, or the like) to execute the software (program) is supplied to a system or an apparatus via a network or various kinds of storage media. Then, the computer (or CPU, MPU, or the like) of the system or the apparatus reads out the program to execute the program. Further, the present invention may be achieved by, for example, a circuit (for example, ASIC) that achieves one or more of the functions.

A cell image analysis program according to one aspect of the present invention is a program for causing a computer to execute the cell image analysis method according to the present invention.

A recording medium according to another aspect of the present invention is a medium on which the above-described cell image analysis program is stored in a computer-readable format.

### EXAMPLE

An example indicating that use of the cell image analysis method according to the present invention enables evaluation to be performed with high accuracy through use of an image feature value extracted from time-series images is described below.

As subjects of the evaluation, three types of iPS cell lines A, B, and C were used. It has been found out that the three types of iPS cell lines differ from each other in the cell type used for production of iPS cells and differ in properties such as a differentiation ability.

The iPS cell lines were cultured through use of a partial modification of a protocol published on a webpage of Center for iPS Cell Research and Application, Kyoto University (https://www.cira.kyoto-u.ac.jp/j/research/img/protocol/hipsprotocolFf_140311.pdf). Specifically, a 6 well cell culture plate (Corning Incorporated; tissue culture treated) and StemFit AK03N (AJINOMOTO CO., INC.) were used, and a culture medium amount during culture was set to 4.5 mL/well. Time-series images were picked up by BZ-X810 (KEYENCE CORPORATION) through use of an objective lens having a magnification of 10 times every 24 hours from the fifth day to the ninth day after the seeding. In order to remove floating dead cells, washing was performed once through use of 1.5 mL/well of culture medium before acquisition of the image data, 4.5 mL/well of culture medium was then added, and the time-series images were picked up.

Subsequently, the image feature value was extracted from the obtained time-series images to evaluate a culture state of each colony. A purpose of the evaluation is to compare the culture states between the iPS cell lines with reference to a time point at which an area value serving as the image feature value to be used as a reference for the degree of growth of each colony is 300,000 μm².

As the image feature value regarding the culture state, a plurality of image feature values including the morphological features such as the peripheral length and the circularity of the colony and the texture feature of the colony were used, and were combined through principal component analysis into a first principal component PC1 and a second principal component PC2 for use in the evaluation.

When the evaluation is performed without use of the cell image analysis method according to the present invention, there is no time-series image picked up at a time point at which the area value serving as the above-described reference is exactly 300,000 μm², and the image feature value regarding the culture state at the time point cannot be acquired. Thus, as Comparative Example, the image feature value obtained from a time-series image picked up at a time point closest to a time point at which the area value is 300,000 μm² was used for the evaluation.

Meanwhile, as Example, the evaluation was performed by applying the cell image analysis method according to the second embodiment described above. At this time, the area value serving as the image feature value to be used as a reference for the degree of growth of each colony was set as the first image feature value, and the first principal component PC1 and the second principal component PC2 obtained from the image feature value regarding the culture state were set as the second image feature values.

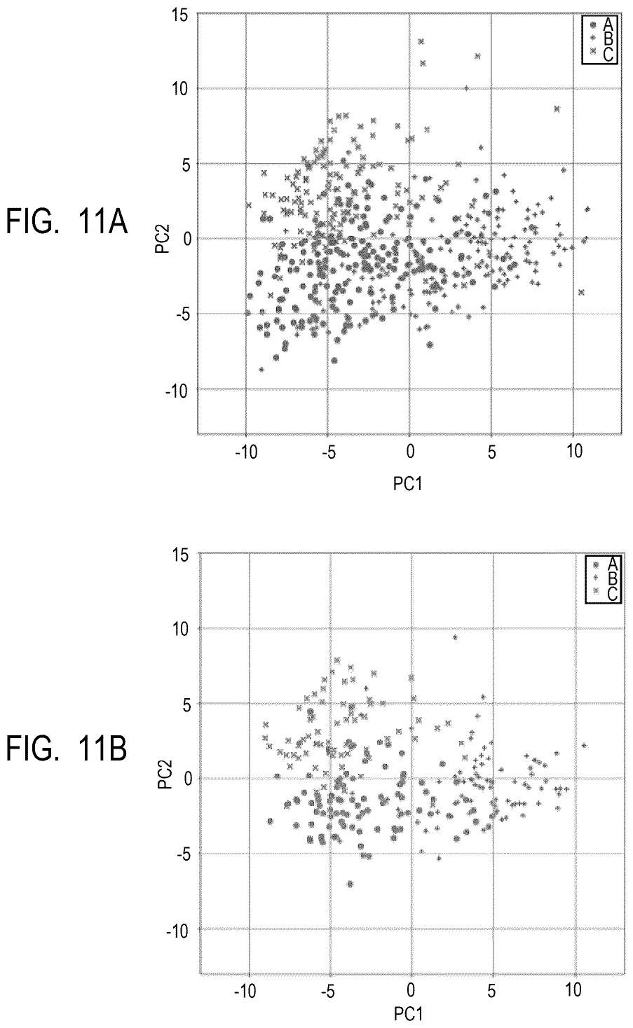

FIG. 11A and FIG. 11B are graphs for showing examples of results of evaluating the culture states of colonies of three types of iPS cell lines. FIG. 11A is the graph for showing the results obtained in Comparative Example, and FIG. 11B is the graph for showing the results obtained in Example. FIG. 11A and FIG. 11B each show a scatter plot in which the first principal components PC1 and the second principal components PC2 obtained for the three types of iPS cell lines are plotted on a horizontal axis and a vertical axis, respectively.

In FIG. 11A showing the results obtained in Comparative Example, the areas of the colonies serving as the basis for extracting the image feature value used for the evaluation are not unified to the reference value, and hence a deviation of each area from the reference value exerts a great influence on the image feature value for evaluating the culture state, thereby reducing a difference between cell lines. Thus, in the evaluation in Comparative Example, it is understood that classification of clustering or the like of the respective cell lines is difficult. Meanwhile, in FIG. 11B showing the results obtained by applying the cell image analysis method according to the present invention, a variance of each cell line is small, and a difference between the three types of iPS cell lines is larger than in the results obtained in Comparative Example. That is, the comparison between the results of the evaluation obtained in Examples and the results obtained in Comparative Example indicates that the evaluation of the difference in properties of the three types of iPS cells was successfully carried out with high accuracy by applying the cell image analysis method according to the present invention.

From the above results, it is understood that, when the states of colonies are evaluated by applying the cell image analysis method according to the present invention, an influence on other image feature values due to an area difference between the respective colonies can be suppressed, and comparison between the colonies can be performed with high accuracy.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the disclosure of the present application, the cell image analysis technology capable of evaluating a cell image with high accuracy under the same criterion regarding an image feature value that changes in a process of cell culture is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139638, filed Aug. 30, 2023, which is hereby incorporated by reference herein in its entirety.

What is claimed is:

1. A cell image analysis apparatus comprising:
an image acquisition unit configured to acquire time-series images, which were acquired at two or more time points different from each other on a time series during cell culture, and which include the same cell colony;
a region extraction unit configured to extract a region of the same cell colony included in each of the time-series images;
a feature value extraction unit configured to extract an image feature value from the region extracted by the region extraction unit;
a feature value estimation unit configured to estimate, through use of the image feature value extracted by the feature value extraction unit, the image feature value regarding the same cell colony assumed to be obtained at a given time point at which none of the time-series images is acquired; and
an evaluation unit configured to evaluate, through use of the image feature value obtained through the estimation by the feature value estimation unit, at least any one selected from the group consisting of the same cell colony and a condition for the cell culture.

2. The cell image analysis apparatus according to claim 1, further comprising an instruction acquisition unit configured to acquire instruction information,
wherein the instruction information includes information specifying the given time point at which none of the time-series images is acquired, and
wherein the feature value estimation unit is configured to estimate the image feature value regarding the same cell colony assumed to be obtained at a time point specified by the instruction information.

3. The cell image analysis apparatus according to claim 1, wherein the feature value estimation unit is configured to estimate, through interpolation processing, the image feature value regarding the same cell colony assumed to be obtained at the given time point at which none of the time-series images is acquired.

4. The cell image analysis apparatus according to claim 3, wherein the feature value estimation unit is configured to perform the interpolation processing through use of the image feature value included in the time-series images acquired at two or more consecutive time points including the time points immediately before and after the given time point at which none of the time-series images is acquired.

5. The cell image analysis apparatus according to claim 1, wherein the feature value estimation unit is configured to estimate, through extrapolation processing, the image feature value regarding the same cell colony assumed to be obtained at the given time point at which none of the time-series images is acquired.

6. The cell image analysis apparatus according to claim 5, wherein the feature value estimation unit is configured to perform the extrapolation processing through use of the time-series images acquired at two or more consecutive time points on the time series that are closest to the given time point at which none of the time-series images is acquired.

7. The cell image analysis apparatus according to claim 1, wherein the evaluation unit is configured to evaluate, based on a predetermined evaluation criterion, at least any one selected from the group consisting of a state of the same cell colony and the condition for the cell culture.

8. The cell image analysis apparatus according to claim 1, wherein the evaluation unit is configured to evaluate a degree of correlation between the image feature value obtained through the estimation by the feature value estimation unit and at least any one selected from the group consisting of a predetermined feature of the same cell colony and the condition for the cell culture.

9. A cell image analysis apparatus comprising:
an image acquisition unit configured to acquire time-series images, which were acquired at two or more time points different from each other on a time series during cell culture, and which include the same cell colony;
a region extraction unit configured to extract a region of the same cell colony included in each of the time-series images;
a feature value extraction unit configured to extract, from the region extracted by the region extraction unit, a first image feature value corresponding to a feature that changes in accordance with a culture time period of the cell culture and a second image feature value corresponding to a feature to be used for evaluation;
a feature value estimation unit configured to estimate the second image feature value corresponding to a given value regarding the first image feature value; and
an evaluation unit configured to evaluate, through use of the second image feature value estimated by the feature value estimation unit, at least any one selected from the group consisting of the same cell colony and a condition for the cell culture.

10. The cell image analysis apparatus according to claim 9, wherein the first image feature value comprises the image feature value relating to a size of a colony.

11. The cell image analysis apparatus according to claim 10, wherein the first image feature value comprises at least any one selected from the group consisting of a colony area, a colony volume, a colony contour length, and an average cell area.

12. The cell image analysis apparatus according to claim 9, further comprising an instruction acquisition unit configured to acquire instruction information,
wherein the instruction information includes information specifying the given value regarding the first image feature value, and
wherein the feature value estimation unit is configured to estimate the second image feature value based on the given value regarding the first image feature value specified by the instruction information.

13. The cell image analysis apparatus according to claim 9, further comprising a time point estimation unit configured to estimate a target time point that is a time point at which the first image feature value of the same cell colony has the given value,
wherein the feature value estimation unit is configured to estimate, through interpolation processing, the second image feature value corresponding to a given value regarding the first image feature value when the target time point falls within a range of a time period including the two or more time points at which the time-series images were acquired on the time series.

14. The cell image analysis apparatus according to claim 13, wherein the feature value estimation unit is configured to perform the interpolation processing through use of the second image feature value included in the time-series images acquired at two or more consecutive time points including the time points immediately before and after the target time point.

15. The cell image analysis apparatus according to claim 9, further comprising a time point estimation unit configured to estimate a target time point that is a time point at which the first image feature value of the same cell colony has the given value,
wherein the feature value estimation unit is configured to estimate, through extrapolation processing, the second image feature value corresponding to a given value regarding the first image feature value when the target time point falls out of a range of a time period including the two or more time points at which the time-series images were acquired on the time series.

16. The cell image analysis apparatus according to claim 15, wherein the feature value estimation unit is configured to perform the extrapolation processing through use of the second image feature value included in the time-series images acquired at two or more consecutive time points on the time series that are closest to the target time point.

17. The cell image analysis apparatus according to claim 9, further comprising a regression model creation unit configured to create a regression model through use of the first image feature value and the second image feature value,
wherein the feature value estimation unit is configured to estimate the second image feature value corresponding to a given value regarding the first image feature value based on the regression model created by the regression model creation unit.

18. The cell image analysis apparatus according to claim 9, wherein the evaluation unit is configured to evaluate, based on a predetermined evaluation criterion, at least any one selected from the group consisting of a state of the same cell colony and the condition for the cell culture.

19. The cell image analysis apparatus according to claim 9, wherein the evaluation unit is configured to evaluate a degree of correlation between the image feature value obtained through the estimation by the feature value estimation unit and at least any one selected from the group consisting of a predetermined feature of the same cell colony and the condition for the cell culture.

20. A cell image analysis method comprising:
an image acquisition step of acquiring time-series images, which were acquired at two or more time points different from each other on a time series during cell culture, and which include the same cell colony;
a region extraction step of extracting a region of the same cell colony included in each of the time-series images;
a feature value extraction step of extracting an image feature value from the region of the same cell colony in a plurality of images included in the time-series images;
a feature value estimation step of estimating, through use of the image feature value extracted in the feature value extraction step, the image feature value regarding the same cell colony assumed to be obtained at a given time point at which none of the time-series images is acquired; and
an evaluation step of evaluating, through use of the image feature value obtained through the estimation in the feature value estimation step, one of the same cell colony or a condition for the cell culture.

21. A cell image analysis method comprising:
an image acquisition step of acquiring time-series images, which were acquired at two or more time points different from each other on a time series during cell culture, and which include the same cell colony;
a region extraction step of extracting a region of the same cell colony included in each of the time-series images;
a feature value extraction step of extracting, from the region extracted in the region extraction step, a first image feature value corresponding to a feature that changes in accordance with a culture time period of the cell culture and a second image feature value corresponding to a feature to be used for evaluation;
a feature value estimation step of estimating the second image feature value corresponding to a given value regarding the first image feature value; and
an evaluation step of evaluating, through use of the second image feature value obtained through the estimation in the feature value estimation step, at least any one selected from the group consisting of the same cell colony and a condition for the cell culture.

22. A non-transitory storage medium having stored thereon a program for causing a computer to execute the cell image analysis method of claim 20.

23. A non-transitory storage medium having stored thereon a program for causing a computer to execute the cell image analysis method of claim 21.
